(19) United States
(12) Patent Application Publication
(10) Pub. No.: US 2019/0248698 A1
(43) Pub. Date: Aug. 15, 2019

(54) GLASS FOR LASER PROCESSING

(71) Applicant: Nippon Sheet Glass Company, Limited, Tokyo (JP)

(72) Inventors: Keiji TSUNETOMO, Kanagawa (JP); Haruhiko MAMADA, Kanagawa (JP); Teruhide INOUE, Tokyo (JP)

(21) Appl. No.: 16/310,752

(22) PCT Filed: Jun. 15, 2017
(86) PCT No.: PCT/JP2017/022135

§ 371 Date: Dec. 17, 2018

(30) Foreign Application Priority Data
Jun. 17, 2016 (JP) 2016-120759

(51) Int. Cl. C03C 3/093; C03B 33/02; C03C 15/00; C03C 3/095; C03C 4/00

(52) U.S. Cl. CPC C03C 3/093; C03B 33/0222; C03C 2204/00; C03C 3/095; C03C 4/0071; C03C 15/00

(57) ABSTRACT

The present invention provides a low-alkali or alkali-free glass for laser processing, the glass reducing occurrence of laser irradiation-induced cracks and allowing formation of circular through holes. The present invention relates to the glass for laser processing, the glass having a glass composition including, in mol %: 45.0%≤SiO₂≤70.0%; 2.0%≤B₂O₃≤20.0%; 3.0%≤Al₂O₃≤20.0%; 0%≤ZnO≤9.0%; and (I) 0.1%≤CuO≤2.0% and 0%≤TiO₂≤15.0%; or (II) 0.1%≤TiO₂<5.0% and 0%≤CuO<0.1%, wherein, in the case of (II), a metal oxide serving as a coloring component is further included, a relationship of 0≤Li₂O+Na₂O+K₂O<2.0% is satisfied, either of principal surfaces of the glass has a layer containing fine particles, and the fine particles have an average particle diameter of 10 nm or more and less than 1.0 μm.

### TECHNICAL FIELD

The present invention relates to a glass for laser processing.

### BACKGROUND ART

Components having an array of a large number of minute through holes are used as microscopic elements for MEMS or electronic devices. As such components there are generally used silicon wafers whose expansion and contraction due to temperature change is small (CTE=around 33×10⁻⁷/° C.) and which are thus resistant to breakage. Silicon wafers, which have a low coefficient of thermal expansion (CTE), are also characterized by undergoing little change in properties in response to temperature change. However, production of monocrystalline silicon, which is a main material of silicon wafers, requires very high cost, so that silicon wafers are also very expensive. Furthermore, laser processing employing ablation, which is a practically used technique for hole forming in silicon wafers, necessarily involves applying a plurality of laser pulses to form one hole and has difficulty in achieving high-speed processing. That is, such laser processing employing ablation requires a long tact time and hence a high processing cost.

A technique is known that uses a combination of ultraviolet laser pulse irradiation and wet etching and that theoretically enables high-speed hole forming by which 1000 or more holes can be formed per second (Patent Literature 1). In this processing method, pulsed laser beams having a wavelength of 535 nm or less are focused by a specific lens, and a sheet of glass, in which holes are to be formed, is irradiated with the focused laser beams to form modified portions in the glass. The glass having the modified portions formed therein is immersed in hydrofluoric acid to form through holes or blind holes in the modified portions; this hole formation takes advantage of the fact that the modified portions are etched at a higher rate than the rest of the glass.

This method can be applied to various glasses. However, in the case where the method is applied to an alkali-free glass (including a low-alkali-concentration glass having an alkali concentration of 1 wt % or less), there is an experimental problem in that it is difficult to form modified portions in a glass surface on which laser beams are incident. The problem is attributed to the fact that cracks are likely to occur at the surface on which laser beams are incident. The reason of the occurrence of cracks is inferred as follows.

When a glass is irradiated with a laser beam, a laser-irradiated part absorbs light. As a result, the light-irradiated part experiences an increase in temperature, which causes a large temperature difference between the irradiated part and a part surrounding the irradiated part and not increasing the temperature. The temperature difference locally creates a very large temperature gradient in the glass, and the temperature gradient generates a great force (thermal stress). A crack occurs when the force exceeds a breakdown threshold of the glass.

Whether or not a glass is broken is determined by the force balance between a generated stress and the medium in a stress-surrounding part (which is, in the case of laser irradiation, a part surrounding a part having a high temperature induced by the laser irradiation) subjected to the stress and possibly broken. When a stress occurs within a glass, the stress is evenly borne by a stress-surrounding part of the glass and thus occurrence of cracks may be prevented. However, if the same stress occurs in the vicinity of (directly under) a glass surface, a portion of the glass medium on the substrate surface side with respect to the part with the stress is so thin that the glass cannot withstand the stress and breaks. When cracks occur both within and at a surface of a glass, larger cracks may be in the vicinity of the glass surface.

Additionally, it is known that a crack is caused by a stress represented by a value several digits smaller than a calculated value when there is a source of the crack, such as a flaw or foreign matter. Such crack-causing factors exist more at glass surfaces than within a glass, and this may also be why cracks are likely to occur at glass surfaces rather than within a glass.

### CITATION LIST

### Patent Literature

Patent Literature 1: 2008-156200 A

### SUMMARY OF INVENTION

### Technical Problem

The present invention aims to provide a low-alkali or alkali-free glass for laser processing, the glass reducing occurrence of laser irradiation-induced cracks and allowing formation of circular through holes.

### Solution to Problem

The present inventors have conducted a detailed study to solve the above problem and found that the above problem can be solved by a sheet-shaped glass substantially free of alkali elements or including a trace amount of alkali elements and having, on either of the principal surfaces, a layer containing fine particles having an average particle diameter of 10 nm or more and less than 1.0 μm. The present inventors have conducted a further study based on the finding and completed the present invention.

The present invention provides a glass for laser processing, the glass having a glass composition including, in mol %:

45.0%≤SiO₂≤70.0%;

2.0%≤B₂O₃≤20.0%;

3.0%≤Al₂O₃≤20.0%;

0%≤ZnO≤9.0%; and

(I) 0.1%≤CuO≤2.0% and 0%≤TiO₂≤15.0%; or

(II) 0.1%≤TiO₂<5.0% and 0%≤CuO<0.1%, wherein,

in the case of (II), a metal oxide serving as a coloring component is further included,

a relationship of 0≤Li₂O+Na₂O+K₂O<2.0% is satisfied,

either of principal surfaces of the glass has a layer containing fine particles, and

the fine particles have an average particle diameter of 10 nm or more and less than 1.0 μm.

### Advantageous Effects of Invention

It is conventionally considered difficult to form a fine structure in low-alkali glasses and alkali-free glasses by laser processing or a combination of laser processing and etching. In the present invention, fine particles having a suitable size for causing Mie scattering are dispersed on one of the principal surfaces of a low-alkali glass or alkali-free glass, the principal surface (hereinafter referred to as “surface A” or “first principal surface”) on which laser beams are to be incident. In the present invention, energy generated by laser irradiation can be dispersed by virtue of the function of the fine particles. Thus, it is possible to dramatically reduce the occurrence of cracks conventionally likely to occur in the vicinity of the laser beam incident surface (surface A) and also to create major modified portions and spreading minor modified portions within the glass and form, in a sheet-shaped glass, uniform through holes having nearly perfectly circular openings on the opening surfaces by subsequent etching.

Moreover, when laser processing is performed on the glass for laser processing according to the present invention, tolerance for the focal point of laser beams to be applied is allowed to be as large as the glass thickness with respect to a target glass surface. This eliminates the need for strict adjustment of the focal point of laser beams with respect to the principal surfaces of the glass, and makes it possible to drastically reduce difficulties with production technology and management. The glass for laser processing according to the present invention is therefore industrially advantageous. Furthermore, because of the large tolerance for the focal point of laser beams, a sheet-shaped glass whose warping or irregularities can be offset by the tolerance can be processed too. This is industrially advantageous in that the need for preparation of an ultrahigh-quality glass almost free from warping is eliminated and additionally, difficulties with purchase of raw materials and with production technology and management in upstream steps can be drastically reduced. When a material having silica as a main component is used as a binder containing fine particles dispersed on the glass, the binder can be removed simultaneously with the etching mainly employing hydrofluoric acid as an etchant. This does not increase difficulty in performing the steps and is thus industrially advantageous.

The present invention allows the use of a nanosecond Nd:YVO₄ laser that emits harmonic beams, thus eliminating the need to use a femtosecond laser which is generally expensive. The present invention is therefore industrially advantageous. In addition, the glass according to the present invention can be suitably used in the form of an alkali-free glass substrate for use as a component of a display device such as a display screen or touch panel without being subjected to any processing such as hole forming when the glass meets the requirements as to optical properties such as transmittance properties.

### BRIEF DESCRIPTION OF DRAWINGS

FIG. 1 shows images of a surface of a fine particle-containing layer according to Example 1 taken by an atomic force microscope.

FIG. 2 shows cross-sectional photographs and top-view photographs of a modified portion in a glass according to Example 1 taken after laser irradiation.

FIG. 3 shows images of a perforated glass produced using the glass for laser processing according to Example 1 and observed with a CNC video measuring system.

FIG. 4 shows images of a perforated glass according to Comparative Example 1 observed with a CNC video measuring system.

### DESCRIPTION OF EMBODIMENTS

A glass for laser processing according to the present invention is characterized in that the glass has a glass composition including, in mol %:

45.0%≤SiO₂≤70.0%;

2.0%≤B₂O₃≤20.0%;

3.0%≤Al₂O₃≤20.0%;

0%≤ZnO≤9.0%; and

(I) 0.1%≤CuO≤2.0% and 0%≤TiO₂≤15.0%; or

(II) 0.1%≤TiO₂<5.0% and 0%≤CuO<0.1%, wherein,

in the case of (II), a metal oxide serving as a coloring component is further included,

a relationship of 0≤Li₂O+Na₂O+K₂O<2.0% is satisfied,

either of principal surfaces of the glass has a layer containing fine particles, and

the fine particles have an average particle diameter of 10 nm or more and less than 1.0 μm.

The glass for laser processing according to the present invention has a fine particle-containing layer (coating layer) on at least one principal surface of the glass. The fine particles dispersed are thus arranged on the glass surface, and a laser beam is applied over the fine particles for laser processing. The laser irradiation of the fine particles causes Mie scattering around the fine particles. The size of the fine particles is preferably suitable for causing Mie scattering. It is thought that since forward scattering is strong in Mie scattering, the energy of the applied laser beam can be transmitted into the glass without a great loss attributed to backward scattering or side scattering.

The average particle diameter of the fine particles in the fine particle-containing layer is commonly 10 nm or more and less than 1.0 μm, which is the particle diameter suitable for causing Mie scattering. The average particle diameter is preferably 25 nm or more and 500 nm or less in that a better stress distribution effect and easier formation of modified portions can be achieved. If the average particle diameter of the fine particles is less than 10 nm, Rayleigh scattering is dominant and backward scattering increases, which may result in a great laser energy loss. If the average particle diameter of the fine particles is 1.0 μm or more, reflection or refraction of the beam may result in a great laser energy loss.

The average particle diameter (D₅₀) of the fine particles can be determined using a dynamic light scattering method. Exemplary measurement apparatuses employing the dynamic light scattering method include a fiber-optics particle analyzer (product code: FPAR-1000, manufactured by Otsuka Electronics Co., Ltd.).

The thickness of the fine particle-containing layer is not particularly limited. The thickness is, for example, preferably 10 nm or more and 10 μm or less, more preferably 20 nm or more and 5.0 μm or less, and even more preferably 50 nm or more and 2.0 μm or less.

The material of the fine particles is not particularly limited, and may be an inorganic compound or organic compound. The inorganic compound is not particularly limited, and examples thereof include inorganic compounds such as SiO₂, TiO₂, ZrO₂, CeO₂, Nb₂Os, Ta₂Os, Al₂O₃, and MgF₂. Examples of the organic compound is not particularly limited, and examples thereof include polystyrene and PMMA (polymethyl methacrylate).

The shape of the fine particles is preferably, for example, but not particularly limited to, a spherical shape. The shape of the fine particles may be a spheroidal shape deviated from a spherical shape or a polyhedron shape with corners. The fine particles may have a homogeneous composition all the way to the inside, or may be composite particles having, for example, a core-shell structure. Furthermore, the fine particles may be fine particles (what are called hollow fine particles) having a hollow inside.

A laser beam incident on a conventional common glass makes a high-temperature region in the center of the incident part. It is thought that a crack occurs when the temperature difference between this heated region and a non-heated region exceeds a certain threshold. In the present invention, incidence of the same laser beam results in a temperature distribution different from that in the conventional common glass due to the fine particle-containing layer on the glass surface. That is, a region with a strong light intensity is made directly under each applied fine particle (which is a colloidal particle in the case where an applied liquid is a colloid) and a high-temperature part is made in the region. The high-temperature part is as large as the applied fine particle. In contrast to the conventional common glass in which a high-temperature part has a certain size (diameter), the glass of the present invention has dispersedly formed high-temperature parts having a very small diameter. This is inferred to have two effects. One is a stress distribution effect explained by the large difference in size of the resultant high-temperature parts between the glass of the present invention and the conventional common glass. The other effect is to make it easy to form modified portions in the vicinity of the surface.

Modified portions are formed when a predetermined optical power is incident, and simultaneously, a thermal stress is generated and causes a crack. The amount of the generated stress differs depending on the area of the high-temperature part even when the temperature difference is the same. This will be explained as follows.

A stress generated by a temperature difference is mostly generated due to expansion of a part of a medium increasing its temperature. A stress (σ) generated by a temperature increase of part of a solid is represented by the following formula using a strain (δ) and Young's modulus (E): σ=δ×E.

A strain resulting from free expansion can be determined by the following formula using a thermal expansion coefficient (η) and temperature difference ΔT: δ=η·ΔT. In the case where a medium is, like the interior of a glass, surrounded by a solid, the medium is pressed by a force of a surrounding part and prevented, against the nature of the medium, from expanding. Therefore, it can be thought that in such a case, a pressure as large as a force required to cause the strain resulting from free expansion is applied by the surrounding part and prevented from expanding. In the above formula, the Young's modulus (E) and thermal expansion coefficient (η) are material constants and the ΔT is determined by laser irradiation conditions (i.e., the energy absorbed by the glass and a specific heat of the medium). Therefore, once materials and the laser irradiation conditions are determined, the stress can be calculated uniquely.

Since a stress is a pressure applied per unit area, a force required to cause a certain strain varies depending on a cross section even under the same stress. The stress generated by the laser irradiation-induced temperature difference between the high-temperature part and low-temperature part does not change as long as the temperature difference is the same. The stress applied to the high-temperature part is, however, smaller in the present invention since the surface area of the high-temperature part is smaller. Therefore, when cracks occur, a crack occurring from a small region as in the glass of the present invention is shorter than a crack occurring from a large region as in the conventional common glass.

That is, when stresses at the same level occur and cause cracks, cracks occurring from minuter regions are shorter. Moreover, occurrence of a plurality of cracks in different directions reduces the anisotropy of the cracks. As a result, holes formed by etching a glass with cracks occurring from minute regions have nearly perfectly circular openings on the laser beam incident surface.

It is thought that holes formed in the conventional glass by laser processing do not have perfectly circular openings for the following reason: Laser irradiation of the glass sheet anisotropically causes cracks at a surface, and the glass is removed along the cracks by etching, which results in failure to make the hole shape approximately circular.

Another effect is to make it easy to form modified portions in the vicinity of the glass surface.

When light is incident on one of the fine particles, the optical electric-field strength around the fine particle has a distribution based on Mie scattering (fine particles having an appropriate particle diameter are selected). When the fine particle is several times as large as the wavelength of the incident light or smaller, the electric-field around the fine particle is determined by calculation based on electromagnetic wave analysis instead of in a generally employed manner such as calculation based on refraction or transmittance at an interface with a lens or the like. In that case, although the light scattering distribution differs depending on the size of the fine particle, a strong peak is generally in the vicinity (which is around the fine particle and may partly include the fine particle) ahead (which is, since the direction of light travel is forward, a portion remote from the laser incident side with respect to the fine particle) of the fine particle. This means that unlike the case of laser irradiation of a glass having no fine particles, a region with a high electric-field strength is locally made. The region is smaller than the fine particle diameter. Therefore, when light having a certain energy density is incident on a part having a fine particle, a very small region having an energy density larger than that of the surrounding region is made in the vicinity of the interface between the vicinity ahead of the fine particle or the fine particle and the glass. To form a modified portion within the glass with a laser beam, the laser beam needs to exceed a predetermined energy density called a threshold. It is thought that in the method according to the present invention, a lot of regions having a higher energy density than the incident laser beam and having a minute area having the energy density can be produced, and thus an energy density beyond the threshold can be relatively easily obtained compared to the case of laser irradiation of a glass having no fine particles.

With the use of the glass according to the present invention, occurrence of cracks at the glass surface can be reduced at the time of the formation of modified portions with laser beams and the modified portions can be formed at low energy by virtue of the above two effects, namely: the effect in which the force generated within the glass by laser irradiation is distributed to a lot of small regions to reduce occurrence of large cracks; and the effect in which a part with a high energy density is formed in a very small region and a modified portion is formed from the part to make it easy to form modified portions in the vicinity of the glass surface.

The alkali-free glass or low-alkali glass on which the fine particle-containing layer is formed includes, in mol %:

45.0%≤SiO₂≤70.0%;

2.0%≤B₂O₃≤20.0%;

3.0%≤Al₂O₃≤20.0%;

0%≤ZnO≤9.0%; and

(I) 0.1%≤CuO≤2.0% and 0%≤TiO₂≤15.0%; or

(II) 0.1%≤TiO₂<5.0% and 0%≤CuO<0.1%, wherein

in the case of (II), a metal oxide serving as a coloring component is further included, and

a relationship of 0≤Li₂O+Na₂O+K₂O<2.0% is satisfied, because in this case laser-modified portions can be easily formed by laser irradiation. A glass including (I) is referred to herein as “glass (I)” and a glass including (II) is referred to herein as “glass (II)”. The description herein is applicable to glasses of any embodiments herein unless otherwise specified.

The average coefficient of thermal expansion in the temperature range of 50 to 350° C. (which may be simply referred to herein as “coefficient of thermal expansion”) of the glass for laser processing according to the present invention is preferably 70×10⁻⁷/° C. or less, more preferably 60×10⁻⁷/° C. or less, even more preferably 50×10⁻⁷/° C. or less, and particularly preferably 45×10⁻⁷/° C. or less. The lower limit of the coefficient of thermal expansion is not particularly defined, and the coefficient of thermal expansion may be, for example, 10×10⁻⁷/° C. or more or may be 20×10⁻⁷/° C. or more. The coefficient of thermal expansion is measured as follows. First, a cylindrical glass sample having a diameter of 5 mm and a height of 18 mm is prepared. This glass sample is heated from 25° C. up to the yield point of the glass sample, the elongation of the glass sample is measured at various temperatures, and the coefficient of thermal expansion is calculated on the basis of the elongation. The average of values of the coefficient of thermal expansion in the temperature range of 50 to 350° C. is calculated to determine the average coefficient of thermal expansion. The actual measurement of the coefficient of thermal expansion was carried out at a temperature rise rate of 5° C./min using TMA 4000 SA, a thermomechanical analyzer manufactured by NETZSCH Japan K.K.

When having a thickness of 0.4 to 0.7 mm and used in applications that require transparency, the glass for laser processing according to the present invention has a transmittance of preferably 80% or more, more preferably 85% or more, even more preferably 90% or more, and particularly preferably 95% or more in the visible region (having a wavelength of 450 to 700 nm).

Warping of glasses can be a problem in some applications. Warping of glasses can be a problem also in the formation of modified portions by laser irradiation because the quality of the modified portions (namely, the quality of holes) is affected. If a glass is warped, the position of the glass with respect to the laser focal point varies in the optical axis direction of laser beams across the glass sheet, and the variation can be a factor preventing formation of holes of the same quality. Therefore, warping is required to be as slight as possible. In view of tolerance in the laser processing for forming modified portions, it is thought that with the use of a conventional technique related to hole-forming process and a predetermined laser optical system, warping is 100 μm or less, preferably 50 μm or less, and more preferably 30 μm or less; the sheet-shaped glass on which the fine particle-containing layer is formed can greatly expand the allowable warping range, and thus warping thereof can be 1 mm or less or 500 μm or less. To examine the above sheet-shaped glass for warping, the sheet-shaped glass having an 8-inch diameter is placed with one of its principal surfaces down on a horizontal and flat board and measured for the maximum height from the board surface to the edge of the glass. The sheet-shaped glass is then placed with the other principal surface down and measured for the maximum height in the same manner. Whichever value is greater is employed.

Additionally, in order to allow the sheet-shaped glass for use as an electrical or optical substrate to exhibit high performance in terms of electrical properties or optical properties, it is preferable for the sheet-shaped glass not to include forms, foreign matters, or the like within the glass or to include, within the glass, forms, foreign matters, or the like with such a small size or in such a small amount that the performance is not affected.

The absorption coefficient α of the glass for laser processing according to the present invention is preferably 1 to 50/cm and more preferably 3 to 40/cm in order to make it easy to form modified portions by laser irradiation. The absorption coefficient may be adjusted, over the entire thickness of the glass, to a value necessary for forming modified portions. If the absorption coefficient α is more than 50/cm, the laser absorption is so strong that most of the laser energy is absorbed in the vicinity of the laser-incident side of the glass. Consequently, the energy fails to reach the vicinity of the opposite side, and a modified portion penetrating through the glass cannot be formed. If the absorption is excessively weak, the laser beam passes through the glass without causing any effect; namely, the glass fails to absorb the laser energy, so that no modified portion can be formed.

The absorption coefficient α can be calculated by measuring the transmittance and reflectance of a sheet-shaped glass having a thickness oft (cm). For the sheet-shaped glass having a thickness of t (cm), the transmittance T (%) and the reflectance R (%) at an incident angle of 12° are measured at a predetermined wavelength (wavelength of 535 nm or less) using a spectrophotometer (such as V-670, an ultraviolet/visible/near-infrared spectrophotometer manufactured by JASCO Corporation). The absorption coefficient α is calculated from the measured values using the following equation.

α=(1/t)*ln {(100−R)/T}

Various components that may be contained in the glass for laser processing according to the present invention will be described hereinafter. The upper and lower limits of value ranges (such as the ranges of the contents of the components, the ranges of values calculated for the components, and the ranges of values of various properties) described herein can be combined as appropriate.

(1) SiO₂

SiO₂ is a network-forming oxide constituting a main glass network. The incorporation of SiO₂ contributes to an increase in chemical durability and also allows for adjustment of the temperature-viscosity relationship and adjustment of the devitrification temperature. If the SiO₂ content is excessively high, melting at temperatures lower than 1700° C. which are practical is difficult, while if the SiO₂ content is excessively low, the liquidus temperature at which devitrification occurs is lowered. In the glass of the present invention, the SiO₂ content is 45.0 mol % or more, preferably 50.0 mol % or more, more preferably 52.0 mol % or more, and even more preferably 55.0 mol % or more. The SiO₂ content is 70.0 mol % or less, preferably 68.0 mol % or less, more preferably 65.0 mol % or less, and even more preferably 63.0 mol % or less.

(2) B₂O₃

B₂O₃ is a network-forming oxide constituting a main glass network, similarly to SiO₂. The incorporation of B₂O₃ allows a glass to have a lowered liquidus temperature and hence a practical melting temperature. If an alkali-free or low-alkali glass having a relatively high SiO₂ content has an excessively low B₂O₃ content, melting of the glass at temperatures lower than 1700° C. which are practical is difficult. If the B₂O₃ content is excessively high, the amount of B₂O₃ evaporated during high-temperature melting is increased so that stable maintenance of the compositional ratio is difficult. The B₂O₃ content is 2.0 to 20.0 mol %. If the B₂O₃ content is less than 6.0 mol %, the glass has an increased viscosity and becomes more difficult to melt, while if the B₂O₃ content is more than 18.0 mol %, the strain point of the glass is lowered. Thus, the B₂O₃ content is preferably 6.0 mol % or more, more preferably 6.5 mol % or more, and even more preferably 7.0 mol % or more. The B₂O₃ content is preferably 18.0 mol % or less, more preferably 17.0 mol % or less, and even more preferably 16.5 mol % or less.

(3) SiO₂+B₂O₃

If the total content of these network-forming components (SiO₂+B₂O₃) is more than 80.0 mol %, melting of the glass is considerably difficult. Thus, the total content of the network-forming components is preferably 80.0 mol % or less, more preferably 78.0 mol % or less, even more preferably 76.0 mol % or less, and particularly preferably 74.0 mol % or less. The total content of the network-forming components is preferably 55.0 mol % or more, more preferably 58.0 mol % or more, even more preferably 59.0 mol % or more, and particularly preferably 62.0 mol % or more.

(4) Al₂O₃

Al₂O₃ is a so-called intermediate oxide that may function as a network-forming oxide or as a modifying oxide depending on the balance between the content of the above network-forming components, SiO₂ and B₂O₃, and the content of the alkaline-earth metal oxides described below as modifying oxides. Al₂O₃ is in a tetracoordinated state in glasses and acts as a component that stabilizes glasses, prevents phase separation of borosilicate glasses, or provides an increase in chemical durability. If an alkali-free or low-alkali glass having a relatively high SiO₂ content has an excessively low Al₂O₃ content, melting of the glass at temperatures lower than 1700° C. which are practical is difficult. If the Al₂O₃ content is excessively high, the glass melting temperature is increased, and stable glass formation is difficult. The Al₂O₃ content is 3.0 to 20.0 mol %. If the Al₂O₃ content is less than 6.0 mol %, the strain point may be lowered, while if the Al₂O₃ content is more than 18.0 mol %, the glass surface is likely to be cloudy. Thus, the Al₂O₃ content is preferably 6.0 mol % or more, more preferably 6.5 mol % or more, even more preferably 7.0 mol % or more, and particularly preferably 7.5 mol % or more. The Al₂O₃ content is preferably 18.0 mol % or less, more preferably 17.5 mol % or less, even more preferably 16.0 mol % or less, and particularly preferably 13.5 mol % or less.

(5) TiO₂

TiO₂ is a so-called intermediate oxide and is generally used for adjustment of the melting temperature and devitrification behavior. It is known that, in glass processing by laser ablation, incorporation of TiO₂ in the glass to be processed can lower the laser processing threshold (JP 4495675 B2). JP 4495675 B2 describes a composition of a glass that can be relatively easily laser-processed without cracking, and states that weak bonds such as Na—O bond, which are formed by network-modifying oxides (such as alkali metal oxides, alkaline-earth metal oxides, and transition metal oxides), are not responsible for the ease of laser processing, and that the ease of laser processing is associated with the strength of bonds other than the weak bonds such as Na—O bond which are formed by the network-modifying oxides, namely, the strength of bonds formed by network-forming oxides and intermediate oxides. For this case, it can be thought that the intermediate oxides are introduced in the composition of the glass in sufficient amounts to allow complete bond breakage by the energy of the laser applied to the glass. According to the single bond strength-based glass-forming ability classification proposed by Kuan-Han Sun (J. Amer. Ceram. Soc. vol. 30, Issue 9, September 1947, pp. 277-281), TiO₂ is classified as an intermediate oxide having a moderate bond strength. In a method for producing a perforated glass by a combination of laser irradiation and etching, incorporation of TiO₂ in an alkali-free or low-alkali glass having a specific composition such as containing CuO allows formation of modified portions by irradiation with relatively low-energy laser and facilitates removal of the modified portions by the subsequent etching. That is, TiO₂ is expected to help adjust the ease of laser processing of glasses.

It is also well known that incorporation of an appropriate amount of TiO₂ in a glass influences the coloring effect of coloring components such as Ce and Fe which are also contained in the glass. This leads to the observation that TiO₂ has the ability to adjust the absorption coefficient α in a predetermined laser wavelength range. Thus, in the present invention, TiO₂ may be incorporated in the glass to allow the glass to have such an appropriate absorption coefficient α that, in the production method using a combination of laser irradiation and etching, modified portions in which holes are to be formed by the etching step can easily be formed. However, if the TiO₂ content is excessively high, the chemical resistance, in particular the resistance to hydrofluoric acid, is so excessively increased that the etching step subsequent to laser irradiation may fail to form desired holes. Thus, the glass (I) may be substantially free of TiO₂. In addition, incorporation of an excess amount of TiO₂ in the glass leads to a high degree of coloring which may make the glass unsuitable for formation into a glass for use in displays. In the glass (I), the TiO₂ content is 0 to 15.0 mol %. To achieve good smoothness of inner walls of holes to be formed through laser irradiation, the TiO₂ content is preferably 0 to 10.0 mol %, more preferably 1.0 to 10.0 mol %, even more preferably 1.0 to 9.0 mol %, and particularly preferably 1.0 to 5.0 mol %. In the glass (II), the TiO₂ content is practically adjusted to 0.1 mol % or more and less than 5.0 mol % based on the assumption of the combined use of TiO₂ and a coloring component described below which is selected from oxides of metals such as Ce and Fe. To achieve good smoothness of inner walls of holes to be formed through laser irradiation, the TiO₂ content is preferably 0.2 to 4.0 mol %, more preferably 0.5 to 3.5 mol %, even more preferably 1.0 to 3.5 mol %, and particularly preferably 1.5 to 3.4 mol %. When the coloring component described below and TiO₂ are used in combination, an excess amount of TiO₂ increases the absorption coefficient so that the laser energy is absorbed in the vicinity of the glass surface, which makes it difficult to form modified portions that are long in the thickness direction of the glass. This may result in a failure to form through holes or holes which are nearly as long as through holes.

When the glass (I) contains TiO₂ (except when the TiO₂ content is 0 mol %), a value (“TiO₂/CuO”) obtained by dividing the TiO₂ content (mol %) by the CuO content (mol %) is preferably 1.0 or more, more preferably 1.5 or more, and even more preferably 2.0 or more to achieve good smoothness of inner walls of holes to be formed through laser irradiation, although the preferred value may vary depending on the balance with the other components. The value TiO₂/CuO is preferably 20.0 or less, more preferably 15.0 or less, and even more preferably 12.0 or less.

(6) ZnO

ZnO is used for adjustment of the melting temperature and devitrification behavior. ZnO may have the same level of single bond strength as intermediate oxides depending on the glass composition. If the ZnO content in a glass is excessively high, the glass is prone to devitrification. Thus, the glass of the present invention may be substantially free of ZnO (which means that the ZnO content is less than 0.1 mol %, preferably less than 0.05 mol %, and more preferably 0.01 mol % or less). In view of the above characteristic of ZnO, the ZnO content in the glass of the present invention is 0 to 9.0 mol %. The ZnO content in the glass (I) is preferably 0 to 9.0 mol %, more preferably 1.0 to 9.0 mol %, and even more preferably 1.0 to 7.0 mol %. The ZnO content in the glass (II) is adjusted to preferably 1.0 to 8.0 mol %, more preferably 1.5 to 5.0 mol %, and even more preferably 1.5 to 3.5 mol % based on the assumption of the combined use of TiO₂ and a coloring component described below which is selected from oxides of metals such as Ce and Fe.

(7) MgO

MgO is an alkaline-earth metal oxide which may be incorporated in the glass, since MgO is characterized by suppressing the increase in coefficient of thermal expansion without causing a significant decrease in strain point and also provides an improvement in meltability. However, it is not preferable that the MgO content be excessively high, because in this case the glass may undergo phase separation or may have poor devitrification resistance and low acid resistance. In the glass of the present invention, the MgO content is preferably 15.0 mol % or less, more preferably 12.0 mol % or less, even more preferably 10.0 mol % or less, and particularly preferably 8.5 mol % or less. The MgO content is preferably 2.0 mol % or more, more preferably 2.5 mol % or more, even more preferably 3.0 mol % or more, and particularly preferably 3.5 mol % or more.

(8) CaO

CaO may be incorporated in the glass since, similarly to MgO, CaO is characterized by suppressing the increase in coefficient of thermal expansion without causing a significant decrease in strain point and also provides an improvement in meltability. However, it is not preferable that the CaO content be excessively high, because an excess amount of CaO may lead to poor devitrification resistance, increase in coefficient of thermal expansion, or decrease in acid resistance. In the glass of the present invention, the CaO content is preferably 15.0 mol % or less, more preferably 12.0 mol % or less, even more preferably 10.0 mol % or less, and particularly preferably 6.5 mol % or less. The CaO content is preferably 1.0 mol % or more, more preferably 2.0 mol % or more, even more preferably 3.0 mol % or more, and particularly preferably 3.5 mol % or more.

(9) SrO

Similarly to MgO and CaO, SrO is characterized by suppressing the increase in coefficient of thermal expansion without causing a significant decrease in strain point and also provides an improvement in meltability. SrO may be incorporated in the glass to improve the devitrification resistance and acid resistance. However, it is not preferable that the SrO content be excessively high, because an excess amount of SrO may lead to poor devitrification resistance, increase in coefficient of thermal expansion, decrease in acid resistance, or decrease in durability. In the glass of the present invention, the SrO content is preferably 15.0 mol % or less, more preferably 10.0 mol % or less, even more preferably 6.5 mol % or less, and particularly preferably 6.0 mol % or less. The SrO content is preferably 1.0 mol % or more, more preferably 1.5 mol % or more, even more preferably 2.0 mol % or more, and particularly preferably 2.5 mol % or more.

(10) BaO BaO may be incorporated in an appropriate amount in the glass, since BaO contributes to adjustment of the etchability of the glass and has the effect of improving the phase separation stability, devitrification resistance, and chemical durability of the glass. In the glass of the present invention, the BaO content is preferably 15.0 mol % or less, more preferably 12.0 mol % or less, even more preferably 10.0 mol % or less, and particularly preferably 6.0 mol % or less. The BaO content is preferably 1.0 mol % or more, more preferably 2.0 mol % or more, even more preferably 3.0 mol % or more, and particularly preferably 3.5 mol % or more. It should be noted that the glass may be substantially free of BaO depending on the balance with the other alkaline-earth metal oxides. Being “substantially free of” BaO means that the BaO content in the glass is less than 0.1 mol %, preferably less than 0.05 mol %, and more preferably 0.01 mol % or less.

(11) MgO+CaO+SrO+BaO

The alkaline-earth metal oxides (MgO, CaO, SrO, and BaO) have the effects as described above; namely, all of them are components that contribute to adjustment of the glass melting temperature while suppressing the increase in coefficient of thermal expansion. The alkaline-earth metal oxides are used for adjustment of the viscosity, melting temperature, and devitrification behavior. However, if the contents of the alkaline-earth metal oxides in a glass are excessively high, the glass may be prone to devitrification. Thus, the total content of the alkaline-earth metal oxides (which may hereinafter be referred to as “ΣRO”) in the glass of the present invention is preferably 25.0 mol % or less, more preferably 23.0 mol % or less, even more preferably 20.0 mol % or less, and particularly preferably 18.0 mol % or less. The total content ΣRO is preferably 6.0 mol % or more, more preferably 8.0 mol % or more, even more preferably 10.0 mol % or more, and particularly preferably 10.5 mol % or more.

(12) Li₂O, Na₂O, and K₂O

Alkali metal oxides (Li₂O, Na₂O, and K₂O) are components that can greatly alter the properties of glasses. These alkali metal oxides may be incorporated in a glass since they significantly increase the meltability of the glass; however, they have a large influence, in particular, on the increase in coefficient of thermal expansion, and their content therefore needs to be adjusted according to the intended use of the glass. In particular, when the alkali metal oxides are contained in a glass for use in the electronic engineering field, they may diffuse into an adjacent semiconductor during post-heating or may cause significant deterioration in electrical insulation properties, increase in dielectric constant (ε) or dielectric loss tangent (tan δ), or degradation in high-frequency characteristics. When these alkali metal oxides are contained in a glass, the shaping of the glass may be followed by coating the surface of the shaped glass with another dielectric material. This can prevent at least diffusion of the alkali components over the glass surface, thus eliminating the above problems. The coating can be effectively accomplished by a known method, examples of which include: a physical method such as sputtering or vapor-deposition of a dielectric material such as SiO₂; and a film formation method that uses a sol-gel process to form a film from a liquid phase. The glass of the present invention may be an alkali-free glass containing no alkali metal oxide (Li₂O+Na₂O+K₂O=0 mol %) or may be a low-alkali glass which can contain a slight amount of alkali component. The content of the alkali metal oxide(s) in the low-alkali glass is preferably less than 2.0 mol % and may be less than 1.0 mol % or less than 0.5 mol %. The content of the alkali metal oxide(s) in the low-alkali glass is more preferably less than 0.1 mol %, even more preferably less than 0.05 mol %, and particularly preferably less than 0.01 mol %. The content of the alkali metal oxide(s) in the low-alkali glass may be 0.0001 mol % or more, 0.0005 mol % or more, or 0.001 mol % or more.

(13) CuO

CuO is a component essential for the glass (I). The incorporation of CuO imparts a color to the glass; namely, the incorporation of CuO allows the absorption coefficient α at a predetermined laser wavelength to be adjusted to an appropriate range and thus enables the glass to absorb the energy of the applied laser to a desired extent, thereby making it easy to form modified portions based on which holes are to be formed.

In order for the absorption coefficient α to fall within the value range described above, the CuO content in the glass (I) is preferably 2.0 mol % or less, more preferably 1.9 mol % or less, even more preferably 1.8 mol % or less, and particularly preferably 1.6 mol % or less. The CuO content is preferably 0.1 mol % or more, more preferably 0.15 mol % or more, even more preferably 0.18 mol % or more, and particularly preferably 0.2 mol % or more.

In the glass (I), a value (“Al₂O₃/CuO”) obtained by dividing the Al₂O₃ content (mol %) by the CuO content (mol %) is preferably 4.0 or more, more preferably 5.0 or more, even more preferably 6.0 or more, and particularly preferably 6.5 or more to achieve good smoothness of inner walls of holes to be formed through laser irradiation, although the preferred value may vary depending on the balance with the other components. The value Al₂O₃/CuO is preferably 120.0 or less, more preferably 80.0 or less, even more preferably 60.0 or less, and particularly preferably 56.0 or less.

(14) Coloring Component

In the present invention, the “coloring component” refers to a metal oxide that exerts a large coloring effect when incorporated in the glass. Specifically, the coloring component is an oxide of a metal selected from the group consisting of Fe, Ce, Bi, W, Mo, Co, Mn, Cr, and V. One of these may be used alone, or a plurality (two or more) thereof may be used in combination. The coloring component is believed to have the function of enabling the glass to directly or indirectly absorb the energy of ultraviolet laser beams so that the energy of the laser beams contributes to formation of modified portions in the glass.

(14-1) CeO₂

In the glass (II), CeO₂ may be incorporated as a coloring component. In particular, combined use of CeO₂ with TiO₂ makes it easier to form modified portions and also allows the modified portion formation to be achieved with reduced variation in quality. However, when the glass (II) contains Fe₂O₃, the glass may be substantially free of CeO₂ (which means that the CeO₂ content is 0.04 mol % or less, preferably 0.01 mol % or less, and more preferably 0.005 mol % or less). Addition of an excess amount of CeO₂ leads to an increase in the degree of coloring of the glass, thus making difficult the formation of deep modified portions. In the glass (II), the CeO₂ content is 0 to 3.0 mol %, preferably 0.05 to 2.5 mol %, more preferably 0.1 to 2.0 mol %, and even more preferably 0.2 to 0.9 mol %. CeO₂ is also effective as a refining agent, and its content can be adjusted according to need.

When the glass (II) contains CeO₂ (except when the CeO₂ content is 0.04 mol % or less), a value (“TiO₂/CeO₂”) obtained by dividing the TiO₂ content (mol %) by the CeO₂ content (mol %) is preferably 1.0 or more, more preferably 1.5 or more, and even more preferably 2.0 or more to achieve good smoothness of inner walls of holes to be formed through laser irradiation, although the preferred value may vary depending on the balance with the other components. The value TiO₂/CeO₂ is preferably 120 or less, more preferably 50.0 or less, even more preferably 35.0 or less, still even more preferably 15.0 or less, and particularly preferably 12.0 or less.

(14-2) Fe₂O₃

Fe₂O₃ is also effective as a coloring component in the glass (II) and may be incorporated in the glass. In particular, combined use of TiO₂ and Fe₂O₃ or combined use of TiO₂, CeO₂, and Fe₂O₃ makes easier the formation of modified portions. When the glass (II) contains CeO₂, the glass may be substantially free of Fe₂O₃ (which means that the Fe₂O₃ content is 0.007 mol % or less, preferably 0.005 mol % or less, and more preferably 0.001 mol % or less). The appropriate content of Fe₂O₃ is 0 to 1.0 mol %, and the Fe₂O₃ content is preferably 0.008 to 0.7 mol %, more preferably 0.01 to 0.4 mol %, and even more preferably 0.02 to 0.3 mol %.

When the glass (II) contains Fe₂O₃ (except when the Fe₂O₃ content is 0.007 mol % or less), a value (“TiO₂/Fe₂O₃”) obtained by dividing the TiO₂ content (mol %) by the Fe₂O₃ content (mol %) is preferably 1.0 or more, more preferably 1.5 or more, and even more preferably 2.0 or more to achieve good smoothness of inner walls of holes to be formed through laser irradiation, although the preferred value may vary depending on the balance with the other components. The value TiO₂/Fe₂O₃ is preferably 700 or less, more preferably 500 or less, even more preferably 200 or less, and particularly preferably 160 or less.

(14-3) Oxides of Metals Such as Bi, W, Mo, Co, Mn, Cr, and V

As previously described, oxides of metals such as Bi, W, Mo, Co, Mn, Cr, and V are effective as coloring components and are preferably added so that the absorption coefficient α of the glass falls within the range of 1 to 50/cm and more preferably falls within the range of 3 to 40/cm.

(15) Additional Intermediate Oxides

Known examples of intermediate oxides other than Al₂O₃, TiO₂, and ZnO (which may hereinafter be referred to as “additional intermediate oxides) include oxides of metals such as Bi, W, Mo, V, Ga, Se, Zr, Nb, Sb, Te, Ta, Cd, Tl, and Pb. It is suggested that when these intermediate oxides are incorporated in an appropriate amount in a glass, they constitute a part of the glass network and allow modified portions to be formed by laser irradiation at a specific wavelength and to be more easily removed by the subsequent etching, although the glass is desirably as free of Cd, Tl, and Pb as possible because Cd, Tl, and Pb have high toxicity and environmental impact. One of the additional intermediate oxides or a plurality (two or more) thereof may be incorporated in the glass. Oxides of Bi, W, Mo, and V may act as colorants as previously described, and their contents need to be determined so that the absorption coefficient of the glass produced falls within the desired range. An oxide that can act both as an additional intermediate oxide and as a coloring component is considered herein to be a coloring component.

(15-1) ZrO₂

Similarly to TiO₂, ZrO₂ can be incorporated in the glass according to the present invention as an optional component that can act as an intermediate oxide and constitute a part of the glass network. In addition, ZrO₂ is expected to provide a decrease in strain point or an improvement in weather resistance without causing an increase in viscosity at high temperatures. However, increasing the ZrO₂ content decreases the devitrification resistance. Thus, the ZrO₂ content is preferably 7.0 mol % or less, more preferably 5.0 mol % or less, and even more preferably 3.0 mol % or less. The ZrO₂ content is preferably 0.1 mol % or more, more preferably 0.5 mol % or more, and even more preferably 1.0 mol % or more.

(15-2) Ta₂O₅

Ta₂O₅ can also be incorporated in the glass according to the present invention as an optional component that acts as an intermediate oxide. Ta₂O₅ further has the effect of increasing the chemical durability of the glass. However, incorporation of Ta₂O₅ causes an increase in specific gravity. Thus, the Ta₂O₅ content is preferably 7.0 mol % or less, more preferably 5.0 mol % or less, and even more preferably 3.0 mol % or less. The Ta₂O₅ content is preferably 0.1 mol % or more, more preferably 0.5 mol % or more, and even more preferably 1.0 mol % or more.

(15-3) Nb₂O₅

Nb₂O₅ can also be incorporated in the glass according to the present invention as an optional component that acts as an intermediate oxide. However, increasing the amount of Nb₂O₅ which is a rare-earth oxide leads to high material cost. Increasing the amount of Nb₂O₅ also causes a decrease in devitrification resistance or an increase in specific gravity. Thus, the Nb₂O₅ content is preferably 7.0 mol % or less, more preferably 5.0 mol % or less, and even more preferably 3.0 mol % or less. The Nb₂O₅ content is preferably 0.1 mol % or more, more preferably 0.5 mol % or more, and even more preferably 1.0 mol % or more.

(16) Refractive Index Modifying Component

To adjust the refractive index of a glass, for example, an appropriate amount of La oxide or Bi oxide may be incorporated as a refractive index modifying component in the glass. Examples of the La oxide include La₂O₃. Examples of the Bi oxide include Bi₂O₃, which has been described above as an intermediate oxide. These oxides may be used alone or in combination. La₂O₃ can be incorporated in the glass according to the present invention as an optional component having the effect of increasing the refractive index of the glass. However, increasing the amount of La₂O₃ which is a rare-earth oxide leads to high material cost. Increasing the amount of La₂O₃ also causes a decrease in devitrification resistance. Thus, the La₂O₃ content is preferably 7.0 mol % or less, more preferably 5.0 mol % or less, and even more preferably 3.0 mol % or less. The La₂O₃ content is preferably 0.1 mol % or more, more preferably 0.5 mol % or more, and even more preferably 1.0 mol % or more. Bi₂O₃ can be incorporated in the glass according to the present invention as an optional component having the effect of increasing the refractive index of the glass. The Bi₂O₃ content is preferably 7.0 mol % or less, more preferably 5.0 mol % or less, and even more preferably 3.0 mol % or less. The Bi₂O₃ content is preferably 0.1 mol % or more, more preferably 0.5 mol % or more, and even more preferably 1.0 mol % or more.

(17) Other Components

Methods available for producing glasses include a float process, a rollout process, a fusion process, a slot down-draw process, a casting process, and a pressing process. For production of glasses for use as substrates in the electronics field, the fusion process is suitable since this process can yield glass substrates both principal surfaces of which have high quality. When a glass is melted and shaped, for example, by the fusion process, a refining agent may be added.

(17-1) Refining Agent

Examples of the refining agent include, but are not limited to: oxides of As, Sb, Sn, and Ce; sulfides of Ba and Ca; chlorides of Na and K; F; F₂; C; Cl₂; and SO₃. The glass of the present invention can contain 0 to 3.0 mol % (the case of 0 mol % may be excluded) of at least one refining agent selected from the group consisting of: oxides of As, Sb, Sn, and Ce; sulfides of Ba and Ca; chlorides of Na and K; F; F₂; Cl; Cl₂; and SO₃. Fe₂O₃ can also function as a refining agent; however, Fe₂O₃ is categorized herein as a coloring component.

(17-2) Impurities Derived from Glass Production Equipment

During glass production, impurities derived from glass production equipment may mingle in glasses. The scope of the glass of the present invention is not particularly limited as long as the effect of the present invention is obtained, and encompasses glasses containing such impurities. Examples of the impurities derived from glass production equipment include platinum elements such as Zr, Pt, Rh, and Os (all of them are main materials of refractory members or electrodes of glass production equipment (including a melting section and a shaping section), and Zr may be used in the form of ZrO₂ as a main material of refractory members). Thus, the glass of the present invention may contain a slight amount (for example, 3.0 mol % or less) of at least one species selected from the group consisting of ZrO₂ and platinum elements such as Pt, Rh, and Os. As previously described, ZrO₂ can be incorporated as an intermediate oxide in the glass. Even when ZrO₂ is not intentionally incorporated in the glass, a sight amount of Zr component as an impurity derived from glass production equipment may be contained in the glass as described above.

(17-3) Water

A shaped glass may contain a certain amount of water. One measure indicating the water content is β-OH value. The β-OH value is determined as follows: For a glass substrate having a thickness of t′ (mm), a transmittance T₁(%) at 3846 cm⁻¹ which is a reference wavenumber and a minimum transmittance T₂ (%) at around 3600 cm⁻¹ which is a hydroxyl absorption wavenumber are measured by FT-IR, and the β-OH value is calculated by the following equation: β-OH value=(1/t′)×log(T₁/T₂). The β-OH value may be about 0.01 to 0.5/mm. Decreasing this value contributes to an increase in strain point. However, if this value is excessively small, the meltability tends to be low.

A preferred embodiment (I-1) of the glass (I) is, for example, an aluminoborosilicate glass having a glass composition including, in mol %:

45.0%≤SiO₂≤68.0%;

2.0%≤B₂O₃≤20.0%;

3.0%≤Al₂O₃≤20.0%; and

0.1%≤CuO≤2.0%,

the glass composition being substantially free of TiO₂ and ZnO, wherein

the following relationships are satisfied:

58.0%≤SiO₂+B₂O₃≤80.0%;

8.0%≤MgO+CaO+SrO+BaO≤20.0%;

0≤Li₂O+Na₂O+K₂O<2.0%; and

6.0≤Al₂O₃/CuO≤60.0.

Another preferred embodiment (I-2) of the glass (I) is, for example, an aluminoborosilicate glass having a glass composition including, in mol %:

50.0%≤SiO₂≤68.0%;

6.0%≤B₂O₃≤18.0%;

7.0%≤Al₂O₃≤18.0%;

0.1%≤CuO≤1.8%; and

1.0%≤TiO₂≤10.0%,

the glass composition being substantially free of ZnO, wherein

the following relationships are satisfied:

58.0%≤SiO₂+B₂O₃≤80.0%;

8.0%≤MgO+CaO+SrO+BaO≤20.0%;

0≤Li₂O+Na₂O+K₂O<2.0%;

6.0≤Al₂O₃/CuO≤60.0; and

0≤TiO₂/CuO≤20.0.

Another preferred embodiment (I-3) of the present invention is, for example, an aluminoborosilicate glass having a glass composition including, in mol %:

50.0%≤SiO₂≤68.0%;

6.0%≤B₂O₃≤18.0%;

7.0%≤Al₂O₃≤18.0%;

0.1%≤CuO≤1.8%; and

1.0%≤ZnO≤9.0%,

the glass composition being substantially free of TiO₂, wherein

the following relationships are satisfied:

58.0%≤SiO₂+B₂O₃≤80.0%;

8.0%≤MgO+CaO+SrO+BaO≤20.0%;

0≤Li₂O+Na₂O+K₂O<2.0%; and

6.0≤Al₂O₃/CuO≤60.0.

The embodiment (I-1) may be an aluminoborosilicate glass (I-4) in which the glass composition further includes, in mol %:

2.0%≤MgO≤10.0%;

1.0%≤CaO≤10.0%;

1.0%≤SrO≤10.0%; and

0%≤BaO≤6.0%.

The embodiments (I-2) and (I-3) may be respectively aluminoborosilicate glasses (I-5) and (I-6) in which the respective contents of MgO, CaO, SrO, and BaO are identical to those in (I-4).

The embodiment (I-1) may be an aluminoborosilicate glass (I-7) in which the glass composition further includes, in mol %:

3.0%≤MgO≤8.5%;

2.0%≤CaO≤6.5%;

2.0%≤SrO≤6.5%; and

0%≤BaO≤6.0%.

The embodiments (I-2) and (I-3) may be respectively aluminoborosilicate glasses (I-8) and (I-9) in which the respective contents of MgO, CaO, SrO, and BaO are identical to those in (I-7).

A preferred embodiment (II-1) of the glass (II) is, for example, an aluminoborosilicate glass including a metal oxide serving as a coloring component, the glass having a glass composition including, in mol %:

45.0%≤SiO₂≤66.0%;

7.0%≤B₂O₃≤17.0%;

7.0%≤Al₂O₃≤13.0%;

0.1%≤TiO₂≤4.0%;

0%≤CuO<0.1%;

0%≤ZnO≤9.0%; and

58.0%≤SiO₂+B₂O₃≤76.0%; wherein

the following relationships are satisfied:

6.0%≤MgO+CaO+SrO+BaO≤25.0%; and

0≤Li₂O+Na₂O+K₂O<2.0%, and

the metal oxide serving as a coloring component includes, in mol %:

(III) 0.01%≤Fe₂O₃≤0.4%;

(IV) 0.1%≤CeO₂≤2.0%; or

(V) 0.01%≤Fe₂O₃≤0.4 and 0.1%≤CeO₂≤2.0%.

A preferred embodiment (II-2) of the glass (II) is, for example, an aluminoborosilicate glass including a metal oxide serving as a coloring component, the glass having a glass composition including, in mol %:

45.0%≤SiO₂≤66.0%;

7.0%≤B₂O₃≤17.0%;

7.0%≤Al₂O₃≤13.0%;

0.1%≤TiO₂≤4.0%;

0%≤CuO<0.1%; and

1.0%≤ZnO≤8.0%, wherein

the following relationships are satisfied:

58.0%≤SiO₂+B₂O₃≤76.0%;

6.0%≤MgO+CaO+SrO+BaO≤25.0%; and

0≤Li₂O+Na₂O+K₂O<2.0%, and

the metal oxide serving as a coloring component includes, in mol %:

(III) 0.01%≤Fe₂O₃≤0.4%;

(IV) 0.1%≤CeO₂≤2.0%; or

(V) 0.01%≤Fe₂O₃≤0.4% and 0.1%≤CeO₂≤2.0%.

The embodiment (II-1) may be an aluminoborosilicate glass (II-3) in which the glass composition further includes, in mol %:

2.0%≤MgO≤10.0%;

1.0%≤CaO≤10.0%;

1.0%≤SrO≤10.0%; and

0%≤BaO≤6.0%.

The embodiment (II-2) may be an aluminoborosilicate glass (II-4) in which the respective contents of MgO, CaO, SrO, and BaO are identical to those in (II-3).

The embodiment (II-1) may be an aluminoborosilicate glass (II-5) in which the glass composition further includes, in mol %:

3.0%≤MgO≤10.0%;

2.0%≤CaO≤10.0%;

2.0%≤SrO≤10.0%; and

0%≤BaO≤6.0%.

The embodiment (II-2) may be an aluminoborosilicate glass (II-6) in which the respective contents of MgO, CaO, SrO, and BaO are identical to those in (II-5).

For any of the above embodiments, adjustment of the contents of the components, and addition or omission of some of the components can be done on the basis of the foregoing description. For any of the above embodiments, the glass composition and the values of the various properties (such as the coefficient of thermal expansion and absorption coefficient α) may be adjusted and combined as appropriate. For example, in the glasses according to the embodiments (I-1) to (I-9) and (II-1) to (II-6), the coefficient of thermal expansion may be 60×10⁻⁷/° C. or less. In the glasses according to the embodiments (I-1) to (I-9) and (II-1) to (II-6), the absorption coefficient α may be 2 to 40/cm.

The glass for laser processing yet to be subjected to laser irradiation to form modified portions can be produced, for example, by forming the fine particle-containing layer on either (first principal surface) of the principal surfaces of one of the above alkali-free or low-alkali glasses obtained by melting and shaping.

[Melting and Shaping of Glass]

The method for melting and shaping glass is not particularly limited, and a known method can be used. For example, a given amount of glass raw material powder is prepared so that about 300 g of glass will be obtained. The glass raw material powder is formed into a glass block having a certain volume by a common melt extraction method using a platinum crucible. In the course of this process, stirring may be performed for the purpose of homogenization or refining of the glass.

The melting temperature and melting time can be set appropriately depending on the melting properties of the glass. The melting temperature may be, for example, around 800 to 1800° C. or around 1000 to 1700° C. The melting time may be, for example, around 0.1 to 24 hours. To reduce the residual stress within the glass, it is preferable that the glass be allowed to go through a predetermined temperature range (for example, around 400 to 600° C.) over several hours and then be left to cool to room temperature.

The above shaping process can result in a glass for laser processing which is in the form of a thin sheet with a thickness of around 0.1 to 1.5 mm.

[Fine Particle-Containing Layer]

Examples of the method for forming the fine particle-containing layer include a method in which a colloid (e.g., a colloidal solution) including fine particles (colloidal particles) dispersed in a dispersion medium (e.g., a binder) is applied to either of the principal surfaces of the glass and hardened. The fine particle-containing layer may be formed on both surfaces of the glass sheet. When the fine particle-containing layer is formed only on the surface A of the glass sheet, light reflected by the opposite surface (hereinafter referred to as “surface B”) to the surface A can be focused within the glass to form modified portions, depending on conditions (NA and substrate position) of an optical system. Such a case can be prevented by the fine particle-containing layer formed also on the surface B because the reflectance is decreased by the effect of scattering or a film having a low refractive index.

The binder may be an organic material such as an ultraviolet-cured resin or thermoset resin, or may be an inorganic material produced by a sol-gel process and including, for example, SiO₂ or TiO₂ as a main component. A condition of light (electromagnetic wave) propagation around the fine particles is thought important to obtain the effect of the present invention. The propagation condition is affected by the shape of the fine particles and a refractive index difference between the fine particles and the binder. For example, if the fine particles and binder have the same refractive index and the fine particles are completely covered by the binder, light (electromagnetic wave) is not affected by boundaries between the fine particles and binder and propagates across the boundaries in the same manner as when it propagates through a homogeneous medium. In this case, the electric-field concentration effect expected cannot be obtained and thus the effect of the present invention cannot be obtained. Therefore, the refractive index of the binder is preferably different from that of the fine particles. However, when there are irregularities reflecting the shape of the colloidal particles on the surface of the fine particle-containing layer, the refractive index of the binder may be almost the same as that of the fine particles. The reason is that in this case, an electromagnetic wave is scattered at the interface between the fine particle surface and air, and thus the effect of the present invention can be obtained. The amount of the binder used is preferably the same as (the solids content in the film, namely 50%) or less than the amount of the fine particles in terms of the volume ratio in the fine particle-containing layer.

Examples of the application method used include, but is not particularly limited to, spin coating, dip coating, inkjet, flow coating, and roll coating. For example, the fine particle-containing layer can be formed with the use of the above inorganic material.

Examples of the method for hardening the colloid including the fine particles and applied to either of the principal surfaces of the glass include: energy irradiation curing such as ultraviolet irradiation curing; and thermal curing. Various methods including a method in which the binder is just dried may be employed.

Examples of the materials applicable to the fine particle-containing layer include, but are not limited to, the following. The fine particles or the fine particles in a colloidal form are, for example, THRULYA (registered trademark) series, Sfelica (registered trademark) slurry series (both of them are manufactured by JGC Catalyst and Chemicals Ltd.), SNOWTEX (registered trademark) ST-OYL, and SNOWTEX (registered trademark) ST-OL (both of them are manufactured by Nissan Chemical Industries, Ltd.). The binder can be selected from a wide variety of binders including: what is called sol-gel binders including an oxide of a metal such as Si as a main component and obtained by a sol-gel reaction using as a raw material a metal alkoxide such as a Si alkoxide such as tetraethoxysilane (TEOS) or methyltriethoxysilane (MTES); and organic binders such as an epoxy resin, acrylic resin, polyacetal resin, polyolefin resin, and PET resin. Moreover, there are commercially available products in which fine particles and a binder are already mixed appropriately. Examples thereof include ELCOM (registered trademark) P series (a mixture of hollow fine silica particles and a sol-gel binder, manufactured by JGC Catalyst and Chemicals Ltd.). The products can be used after appropriately modified according to each embodiment used.

A perforated glass can be produced using the glass for laser processing obtained in the above manner. Specifically, a perforated glass can be produced by a production method including: a step [i] in which parts of the glass for laser processing obtained in the above manner are irradiated with laser pulses focused by a lens, and thus modified portions are formed in the irradiated parts; and a step [ii] in which at least the modified portions are etched using an etchant to form holes in the glass for laser processing.

[Formation of Modified Portion]

In the step [i], parts of any one of the above glasses for laser processing according to the present invention are irradiated with laser pulses focused by a lens, and thus modified portions are formed in the irradiated parts.

In the step [i], a modified portion can be formed by a single irradiation with a laser pulse. Thus, in the step [i], modified portions can be formed by applying laser pulses in such a manner that irradiation spots do not overlap each other. It should be understood, however, that the laser pulses may be applied in such a manner that the applied pulses overlap each other.

Typically, in the step [i], laser pulses are focused by a lens on points within the glass. For example, when through holes are formed in the glass in a sheet shape, laser pulses are typically focused on points at or in the vicinity of the thickness center of the sheet-shaped glass. When only the upper portion (portion in the vicinity of the laser pulse incident surface) of the glass is to be processed, laser pulses are typically focused on points in the upper portion of the glass. When only the lower portion (portion remote from the laser pulse incident surface) of the glass is to be processed, laser pulses are typically focused on points in the lower portion of the glass. It should be understood, however, that laser pulses may be focused on points outside the glass as long as modified portions can be formed in the glass. For example, laser pulses may be focused on points located outside the sheet-shaped glass at a predetermined distance (for example, 1.0 mm) from the upper surface or lower surface of the sheet-shaped glass. That is, as long as modified portions can be formed in the glass, laser pulses may be focused on points within a distance of 1.0 mm from the upper surface of the glass (the points including those on the upper surface of the glass) in an upward direction (the direction opposite to the traveling direction of the laser pulses), the laser pulses may be focused on points within a distance of 1.0 mm from the lower surface of the glass (the points including those on the lower surface of the glass) in a downward direction (the direction in which the laser pulses having passed through the glass travel), or the laser pulses may be focused on points within the glass.

The pulse width of the laser pulses is preferably 1 to 200 nanoseconds (ns), more preferably 1 to 100 ns, and even more preferably 5 to 50 ns. If the pulse width is greater than 200 ns, the peak value of the laser pulses may be decreased so that the processing ends in failure. Laser beams having an energy of 5 to 100 μJ/pulse are applied to the above glass for laser processing. Increasing the energy of the laser pulses leads to a corresponding increase in the length of the modified portions. The beam quality parameter M² of the laser pulses may be, for example, 2 or less. The use of laser pulses having a parameter M² of 2 or less makes it easy to form minute holes or minute grooves.

In the production method of the present invention, the laser pulses may be harmonic beams from a Nd:YAG laser, harmonic beams from a Nd:YVO₄ laser, or harmonic beams from a Nd:YLF laser. The harmonic beams are, for example, second harmonic beams, third harmonic beams, or fourth harmonic beams. The wavelength of the second harmonic laser beams is around 532 nm to 535 nm. The wavelength of the third harmonic beams is around 355 nm to 357 nm. The wavelength of the fourth harmonic beams is around 266 nm to 268 nm. The use of such laser beams allows for inexpensive processing of the glass.

Exemplary apparatuses used for the laser processing include AVIA 355-4500, a high-repetition-rate, solid-state pulsed UV laser manufactured by Coherent Japan, Inc. This apparatus is a Nd:YVO₄ laser that emits third harmonic beams, and outputs a maximum laser power of around 6 W at a repetition frequency of 25 kHz. The wavelength of the third harmonic beams is 350 nm to 360 nm.

The wavelength of the laser pulses is preferably 535 nm or less and may be, for example, in the range of 350 nm to 360 nm. If the wavelength of the laser pulses is more than 535 nm, the spot size is increased so that formation of minute holes is difficult and, in addition, cracks are likely to occur due to heat around the irradiated spots.

An optical system typically used is one in which an oscillated laser beam is expanded by a factor of 2 to 4 by a beam expander (the beam diameter is 7.0 to 14.0 mm at this moment), the central portion of the laser beam is cut by a variable iris, then the optical axis of the beam is adjusted by a galvanometer mirror, and finally the beam is focused on/in the glass with the focal point being adjusted by an fθ lens with a focal length of around 100 mm.

The focal length L (mm) of the lens is, for example, in the range of 50 to 500 mm and may be selected from the range of 100 to 200 mm.

The beam diameter D (mm) of the laser pulses is, for example, in the range of 1 to 40 mm and may be selected from the range of 3 to 20 mm. The beam diameter D as defined herein refers to the beam diameter of the laser pulse incident on the lens, and refers to the diameter at which the beam intensity drops to [1/e²] times the beam intensity at the center of the beam.

In the present invention, a value obtained by dividing the focal length L by the beam diameter D, namely, the value of [L/D], is 7 or more. The value of [L/D] is preferably 7 or more and 100 or less, and may be 10 or more and 65 or less. This value is associated with the degree of focusing of the laser with which the glass is to be irradiated. The smaller the value is, the more localized the laser focusing is, so the more difficult it is to form long, uniform modified portions. If this value is less than 7, the laser power may be so excessively high in the vicinity of the beam waist that cracks are likely to occur within the glass.

The numerical aperture (NA) may be varied in the range of 0.006 to 0.075 by changing the size of the iris and thus adjusting the laser beam diameter. If the NA is excessively large, the laser energy is concentrated only at and around the focal point, which leads to a failure to form effective modified portions in the thickness direction of the glass.

The use of pulsed laser beams having a small NA for irradiation allows a single irradiation to form modified portions that are relatively long in the thickness direction of the glass, and is therefore effective in shortening the tact time.

In laser irradiation of a sample, the repetition frequency is preferably 10 to 300 kHz. The repetition frequency is more preferably 10 to 100 kHz. The positions of modified portions to be formed in the glass can be optimally adjusted (toward the upper surface or lower surface) by shifting the focal point in the thickness direction of the glass.

Furthermore, the output power of the laser, the operation of the galvanometer mirror, etc., can be controlled by a controlling PC. The laser can be applied to a glass substrate at a predetermined speed on the basis of two-dimensional graphic data created, for example, by a CAD software.

In a laser-irradiated part of the glass there is formed a modified portion distinguished from the rest of the glass. This modified portion can easily be identified, for example, with the aid of an optical microscope. The modified portion extends from the vicinity of the upper surface of the sheet-shaped glass to the vicinity of the lower surface. A “major modified portion” is formed from the surface A (the surface on which the fine particle-containing layer is formed and laser beams are incident) of the sheet glass to the surface B (the other surface which is not the surface A), and simultaneously, a spreading “minor modified portion” is formed by Mie scattering caused by the fine particles dispersed on the glass surface A in the vicinity of the glass surface A and within the glass.

The modified portion including the major modified portion and minor modified portion is thought to be a portion with a defect such as E′ center or non-bridging oxygen which has resulted from photochemical reaction induced by laser irradiation or a portion with a sparse glass structure generated at a high temperature due to rapid heating during laser irradiation and maintained due to rapid cooling after laser irradiation. The modified portion can be etched by a specific etchant at a higher rate than the rest of the glass; thus, immersing the glass in the etchant can result in a minute hole or groove in the modified portion.

In conventional processing methods using a femtosecond laser (which is generally expensive), laser beams are scanned in a depth direction (the thickness direction of a glass substrate) during formation of modified portions so that the applied pulses overlap each other. In the hole-forming technique (the method for producing a perforated glass) which uses a combination of laser irradiation and wet etching of the sheet-shaped glass having the fine particle-containing layer formed on at least one principal surface, a modified portion formed in the thickness direction of the glass and spreading minor modified portion can be formed by a single irradiation with a laser pulse.

The conditions employed in the step [i] are, for example, as follows: the absorption coefficient α of the glass is 1 to 50/cm, the pulse width of the laser pulses is 1 to 100 ns, the energy of the laser pulses is 5 to 100 μJ/pulse, the wavelength of the laser pulses is 350 nm to 360 nm, and the beam diameter D of the laser pulses is 3 to 20 mm, and the focal length L of the lens is 100 to 200 mm.

Before the step [ii], the glass sheet may, if desired, be polished to reduce the variation in diameter of the modified portions. A sufficient degree of the polishing is such a degree that cracks at the outermost surface are removed. The polishing is preferably performed to a depth of 1 to 20 μm from the principal surface of the sheet-shaped glass. Additionally, when a binder containing SiO₂ as a main component is used in the fine particle-containing layer, the binder is removed by the subsequent etching step performed using an etchant containing hydrofluoric acid as a main component. In a part on which a laser beam is incident, a portion removed from the fine particle-containing layer is larger than the diameter (which is the diameter of a group of major modified and minor modified portions since a modified portion includes a spreading modified portion) of a modified portion formed within the glass. Etching of the glass sheet without polishing can turn the vicinity of an opening on the surface A into a shape somewhat closer to a cone. Occurrence of such a phenomenon, therefore, can be reduced by polishing a principal surface, particularly the surface A, of the sheet-shaped glass before the etching in the step [ii].

The size of the modified portions formed in the step [i] varies depending on the beam diameter D of the laser pulses incident on the lens, the focal length L of the lens, the absorption coefficient α of the glass, and the power of the laser pulses. The diameter of the resulting modified portions is, for example, around 1 to 30 μm and may be around 3 to 30 μm. The depth of the modified portions may be, for example, around 50 to 500 μm, although the depth may vary depending on the laser irradiation conditions, the absorption coefficient α of the glass, and the thickness of the glass.

[Etching]

In the step [ii], at least the modified portions are etched using an etchant to form holes in the glass for laser processing.

It is preferable that the etchant used in the step [ii] should etch the modified portions at an etching rate higher than an etching rate at which the etchant etches the rest of the glass for laser processing. The etchant used may be, for example, hydrofluoric acid (aqueous solution of hydrogen fluoride (HF)). Alternatively, sulfuric acid (H₂SO₄), an aqueous solution of H₂SO₄, nitric acid (HNO₃), an aqueous solution of HNO₃, or hydrochloric acid (aqueous solution of hydrogen chloride (HCl)) may be used. These acids may be used alone, or a mixture of two or more of these acids may be used. When hydrofluoric acid is used as the etchant, the etching of the modified portions readily proceeds, and thus holes can be quickly formed. When sulfuric acid is used as the etchant, the part of the glass other than the modified portions are slow to be etched, and thus straight holes with a small tapered angle can be formed.

In the etching step, the upper surface or lower surface of the glass sheet may be coated and protected with a surface protection coating agent to allow the etching to proceed from only one of the surfaces. The surface protection coating agent used can be a commercially-available product, an example of which is SILITECT-II (manufactured by Trylaner International).

The etching time and the etchant temperature are selected according to the shape of the modified portions or the desired shape to be obtained by the etching process. Raising the temperature of the etchant used in the etching can increase the etching rate. The diameter of the holes can be controlled by the etching conditions.

The etching time is preferably, but not limited to, around 30 to 180 minutes, although the etching time may vary depending on the thickness of the glass. The etchant temperature can be varied to adjust the etching rate, and is preferably around 5° C. to 45° C. and more preferably around 15 to 40° C.

The etching process can be accomplished even when the etchant temperature is 45° C. or higher. However, such a high etchant temperature is not practical since the etchant quickly evaporates. The etching process can be accomplished even when the etchant temperature is 5° C. or lower. However, a low etchant temperature leading to an extremely low etching rate is not practical.

During the etching, ultrasonic waves may be applied to the etchant if desired. The application of ultrasonic waves can increase the etching rate and is also expected to produce a stirring effect on the etchant. Examples of such an etching method include a method in which the glass is etched under ultrasonic irradiation in an etchant containing: hydrofluoric acid; one or more inorganic acids selected from the group consisting of, nitric acid, hydrochloric acid, and sulfuric acid; and a surfactant, the etchant containing 0.05 wt % to 8.0 wt % of hydrofluoric acid, 2.0 wt % to 16.0 wt % of the inorganic acid, and 5 ppm to 1000 ppm of the surfactant. Such wet etching removes the modified portions and forms through holes or blind holes. The surfactant is not particularly limited, and examples thereof include amphoteric surfactants, cationic surfactants, anionic surfactants, and nonionic surfactants. These surfactants may be used alone or in combination.

Examples of the amphoteric surfactant include 2-alkyl-N-carboxymethyl-N-hydroxyethyl imidazolinium betaine, coconut oil fatty acid amidopropyl betaine, sodium cocoalkylaminopropionate, and sodium laurylamino dipropionate. Examples of the cationic surfactant include quaternary ammonium salts (e.g., lauryltrimethylammonium chloride), higher amine halogen acid salts (e.g., hard tallow amine), and alkylpyridinium halide (e.g., chloride dodecylpyridinium) surfactants. Examples of the anionic surfactant include alkylsulfuric acid ester salts, alkyl aryl sulfonic acid salts, alkyl ether sulfuric acid ester salts, α-olefinsulfonic acid salts, alkylsulfonic acid salts, alkylbenzenesulfonic acid salts, alkylnaphthalenesulfonic acid salts, taurine surfactants, sarcosinate surfactants, isethionate surfactants, N-acyl acidic amino acid surfactants, monoalkyl phosphoric acid ester salts, higher fatty acid salts, and acylated polypeptides. Examples of the nonionic surfactant include polyoxyalkylene alkyl ethers, polyoxyethylene derivatives, monoglycerin fatty acid esters, polyglycerin fatty acid esters, and sucrose fatty acid esters.

When the modified portions are formed to be exposed only at the surface A (the laser beam incident surface) of the sheet-shaped glass, holes can be formed only in the surface A side of the glass by the etching. When the modified portions are formed to be exposed only at the surface B (the surface opposite to the laser beam incident surface) of the glass sheet, holes can be formed only in the lower portion of the glass by the etching. When the modified portions are formed to be exposed at the upper and lower surfaces of the glass sheet, through holes can be formed by the etching. A film for inhibiting etching may be formed on the surface A or B of the glass sheet to allow the etching to proceed from only one of the surfaces. It is also conceivable to form modified portions not exposed at either of the surfaces of the glass sheet, then polished the glass sheet to expose the modified portions, and then perform the etching. Changing the conditions of the formation of the modified portions and the conditions of the etching makes it possible to form holes of various shapes, such as through holes of cylindrical shape, through holes of one-sheet hyperboloidal shape (hourglass shape), through holes of frustoconical shape, holes of conical shape, holes of frustoconical shape, and holes of cylindrical shape.

Holes can be formed to connect with each other so that a groove is formed. In this case, laser pulses are applied in an aligned manner to form modified portions arranged in a line. After that, the modified portions are etched to form the groove. The spots to which the laser pulses are applied need not overlap each other, and holes formed as a result of the etching may connect neighboring holes to each other.

The fine particle-containing layer on the glass surface is removed by the etchant simultaneously with the formation of holes by the etching. However, when the fine particles are large, the irregularities thereof are transferred to the glass surface and irregularities as high as the fine particles may be formed on the glass surface.

When the fine particles are particularly large, light scattering caused by the irregularities thereof is increased, and the increased light scattering may be a problem in applications that require transparency. Formation of moderate irregularities may impart an anti-glare or anti-reflection function to the glass surface. Thus, moderate irregularities may be an advantage when such a function is needed. When the glass on which holes are formed is used as a glass interposer, metal conductive lines or an organic thin film is formed on the glass surface. Irregularities on the glass surface may improve the adhesion of the film thanks to an anchoring effect.

In the case where an organic substance is used as the binder, laser irradiation removes a laser-irradiated part of the fine particle-containing layer. This may have a desirable effect on the hole formation. That is, when a laser beam is focused to irradiate the part to form a modified portion, the organic substance in the laser-irradiated part is evaporatively removed (removed by ablation); however, the fine particle-containing layer in a part not irradiated with the laser beam is not removed. When the glass in such a state is etched, the etching rate is slow in the part on which the fine particle-containing layer remains (because the organic component is not dissolved), and the part having no fine particle-containing layer is etched quickly into hole entrances. That is, protection of a part etching of which is unnecessary with the fine particle-containing layer of the present invention can improve the flatness of the unetched part, allow greater control over the hole diameter, or decrease the amount of the glass to be etched to reduce waste of the etchant.

The present invention encompasses embodiments obtainable by combining the above features in a various way within the technical scope of the present invention as long as the embodiments provide the effect of the present invention.

### EXAMPLES

Hereinafter, the present invention will be described in more detail by way of examples. The present invention is by no means limited by these examples, and many modifications are possible by any ordinarily skilled person in the art within the technical concept of the present invention.

### Example 1

[Melting and Shaping of Glass]

A given amount of glass raw material powder was prepared so that a glass having the composition shown below would be obtained in an amount of about 300 g. The glass raw material powder was formed into a glass block having a certain volume by a common melt extraction method using a platinum crucible. In the course of this process, stirring was performed for the purpose of homogenization or refining of the glass. 56.88% SiO₂, 7.5% B₂O₃, 11.0% Al₂O₃, 3.0% TiO₂, 0% Na₂O, 0% Li₂O, 0% K₂O, 0% CuO, 3.0% ZnO, 7.8% MgO, 5.4% CaO, 5.4% SrO, and 0.02% Fe₂O₃(The unit is mol %.)

The melting temperature and melting time can be set appropriately depending on the melting properties of the glasses. In Example 1, the glass was melted at about 1600° C. for 6 hours, after which the molten glass was cast onto a carbon plate and thus shaped. To reduce the residual stress within the glass, the glass was allowed to go through the temperature range of 550° C. to 700° C. including the annealing point over about 4 hours, after which the glass was left to cool to room temperature.

From the thus-formed glass block, a sheet-shaped glass polished to a thickness of 470 μm was obtained. The absorption coefficient was 4.4/cm at a wavelength of laser beams applied to form modified portions, namely 355 nm.

[Formation of Fine Particle-Containing Layer]

A coating liquid containing hollow fine silica particles was employed to apply onto the sheet-shaped glass. The coating liquid is specifically a coating liquid modified from ELCOM (registered trademark) P-5 manufactured by JGC Catalyst and Chemicals Ltd., containing hollow fine silica particles (average particle diameter: 70 nm) dispersed in a sol-gel binder containing SiO₂ as a main component, and having the following physical property values: a solids content of 3%; and a specific gravity of 0.8.

In a spin coater (product code: MS-B200) manufactured by Mikasa Co., Ltd. was set the sheet-shaped glass, on which an appropriate amount of the coating liquid was dropped. The sheet-shaped glass was then rotated at a rotation speed of 3000 rpm for 25 minutes to be coated with the coating liquid. Subsequently, the sheet-shaped glass was rotated for preliminary drying at a rotation speed of 500 rpm for 120 minutes and then subjected to a heat treatment at 150° C. for 10 minutes. In this manner, a fine particle-containing layer having a thickness of about 250 nm was formed on one of the principal surfaces of the glass.

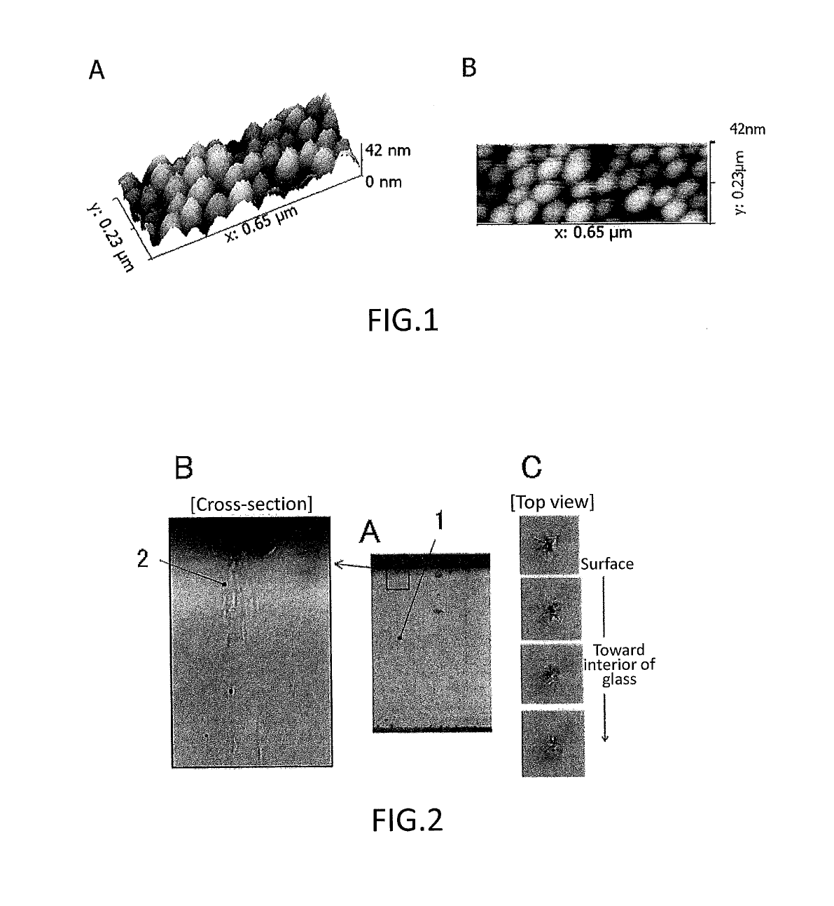

This fine particle-containing layer has a structure in which several tiers of hollow fine silica particles are stacked. FIG. 1 shows an image of the surface of the fine particle-containing layer taken by an atomic force microscope (product name: Nano-I (registered trademark), manufactured by Pacific Technology). As the heat treatment evaporated the solvent, the fine particle-containing layer has the structure in which the fine particles are stacked. FIG. 1 shows the result of measurement of irregularities on the uppermost surface. FIG. 1A shows an image of the fine particle-containing layer viewed obliquely from above. FIG. 1B shows a cross-sectional view of the fine particle-containing layer viewed from above.

In Example 1, the layer thickness is 250 nm (on average 2 or 3 tiers of the fine particles). The effect of the present invention, however, can be obtained even if there are more tiers. The diameter of each laser beam to be applied is about several μm to 30 μm. Given the size of the fine particles, up to several million fine particles are in a part irradiated with the beam. It is thus unnecessary for the fine particles to fill up the entire range of the beam diameter. For example, even in a lack of several or several tens of the fine particles in the beam irradiated part, a lot of other fine particles in the beam irradiated part exhibit the effect of the present invention. Therefore, even in a partial lack of the fine particles, the effect of the present invention can be achieved with a glass having an average layer thickness of 70 nm (one or more tiers of the fine particles).

When a laser beam irradiates a part of the sheet-shaped glass having the fine particle-containing layer thus formed on the surface, the beam is scattered by the fine particles in the irradiated part and a region with a very high light energy density is formed ahead (that is, in portions where the glass surface and fine particles are close to or have contact with each other, or within the glass) of the fine particles. A modified portion is thought to be formed based on the regions with a high light energy density.

[Formation of Modified Portion]

Formation of modified portions by laser irradiation was performed using AVIA 355-4500, a high-repetition-rate, solid-state pulsed UV laser manufactured by Coherent Japan, Inc. This laser is a Nd:YVO₄ laser that emits third harmonic beams, and outputs a maximum laser power of around 6 W at a repetition frequency of 25 kHz. The dominant wavelength of the third harmonic beams is 355 nm.

The optical axis of laser pulses (having a pulse width of 9 ns, a power of 1.2 W, and a beam diameter of 3.5 mm) emitted from the laser was adjusted by a galvanometer mirror, and the laser pulses were incident on and introduced into the glass sheet through an fθ lens with a focal length of 100 mm. The angular aperture (NA) was 0.012.

The beam diameter of the laser can be changed appropriately by placing a beam expander in an optical path or by partly blocking a beam with an iris. For example, the NA can be varied in the range of 0.006 to 0.075 by changing the size of the iris and thus adjusting the beam diameter. The glass having the fine particle-containing layer formed on the surface was set near the focal point of the fθ lens so that the surface with the fine particle-containing layer would be the surface (surface A) on which laser beams were to be incident, and was irradiated with laser beams. The condition of modified portions to be formed varies depending on the position relationship in the laser axis direction (Z direction) between (a principal surface of) the sheet-shaped glass and the laser focal point. Therefore, the glass was set on an automated stage to change the laser focal point in the Z direction, and was irradiated. A position on the principal surface and in which one hole was intended to be formed was irradiated with one pulse to form a modified portion. Moreover, when the laser beams were scanned, the laser scanning rate was 400 mm/min so that the applied pulses would not overlap each other.

FIG. 2 shows cross-sectional photographs (FIG. 2A and its enlarged photograph FIG. 2B) and top-view photographs (FIG. 2C showing the glass surface and taken from the laser incident surface (surface A)) of a modified portion obtained after the laser irradiation. A side surface of the glass was polished and observed with an optical microscope, with which the cross-sectional photographs were taken. A major modified portion 1 is confirmed in FIG. 2A. Spreading minor modified portions 2 are confirmed in FIG. 2B. The top-view photographs of FIG. 2C show the glass observed from the laser incident surface (which is the surface A and the principal surface having the fine particle-containing layer) side with an optical microscope. The photographs were taken from top to bottom. The focal point of the microscope was shifted in the glass thickness direction to take each photograph and observe changes in the glass thickness (depth) direction. It can be confirmed from the photographs that the modified portion was formed in the glass thickness direction.

At the time of the laser irradiation, the sheet-shaped glass was at a position where the principal surface not having the fine particle-containing layer was located at a distance of 300 μm from the laser focal point toward the laser. Similar modified portions can be observed even if the sheet-shaped glass is set at other positions (positions of the laser focal point in the laser axis direction (Z direction) with respect to the principal surface of the sheet-shaped glass) in the Z direction. A plurality of thin, spreading minor modified portions were formed in the vicinity of the glass surface and no cracks were formed (FIG. 2B). A slight indent was formed on the uppermost surface (FIG. 2C). The indent was formed by evaporation of part of the glass surface at the laser irradiation and is not a crack.

[Etching]

In a 1 L polyethylene container as an etching bath, the following components were incorporated in the proportion described in Table 1 using pure water as a solvent to prepare an etchant:

| | | |
|---|---|---|
| hydrofluoric acid | 46% | Morita Chemical Industries Co., Ltd.; |
| nitric acid 1.38 | 60% | KANTO CHEMICAL CO., INC.; and |
| a high-performance | | Wako Pure Chemical Industries, Ltd. |
| nonionic surfactant, | | |
| NCW-1001 (30% | | |
| aqueous solution of | | |
| polyoxyalkylene alkyl | | |
| ether) | | |

TABLE 1

| Component | Example 1 |
|---|---|
| Hydrofluoric acid (wt %) | 2.0 |
| Nitric acid (wt %) | 6.0 |
| Surfactant* (ppm) | 15 |

*Amount of component from which solvent is excluded

Water was poured into an ultrasonic bath to a predetermined water level, and the etching bath containing the etchant was placed therein. The temperature of the etchant was adjusted to 25° C. The glass was vertically set in a glass holder made of polyvinyl chloride, put in the etching bath, and irradiated with ultrasonic waves at 40 kHz and 0.26 W/cm². In case where the ultrasonic irradiation increases the temperature of the etchant, water in the ultrasonic bath was partially replaced to maintain the temperature within a range of 25° C.±2° C. The sample was lifted out in the course of the etching, and the etching rate was obtained from a change in the thickness of the substrate. The etching was performed for an etching time determined to allow the substrate to have a thickness of 400 μm at the end of the etching. The sample was lifted out, sufficiently rinsed with pure water, and then dried with hot air.

This etching treatment dissolved the fine particle-containing layer formed on the surface of the sheet-shaped glass and, in the course of the formation of holes, completely removed the fine particle-containing layer.

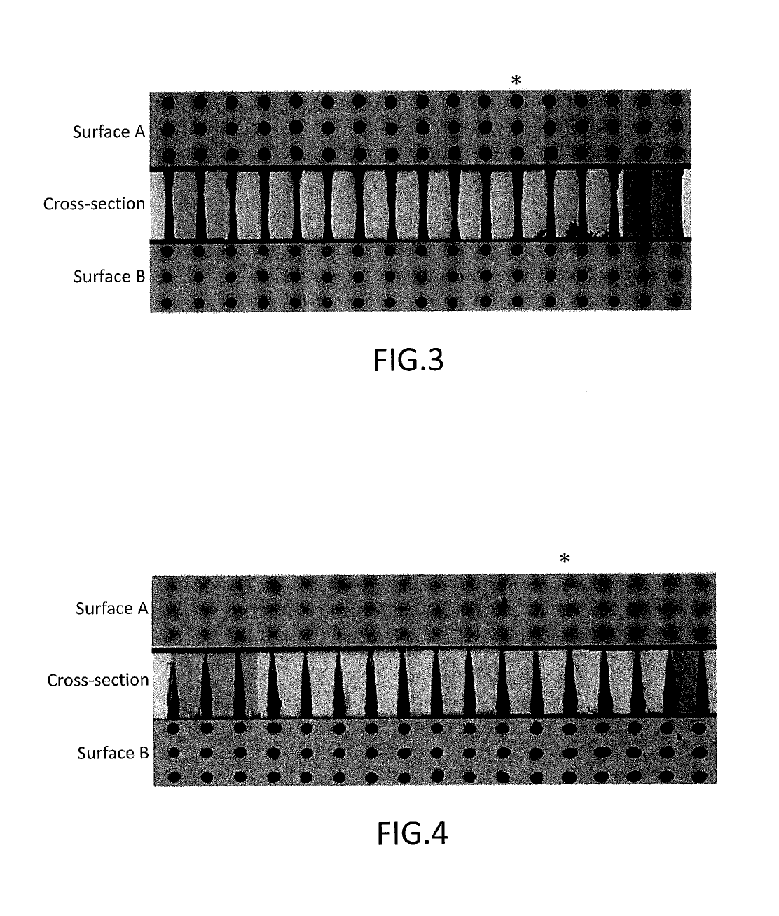

FIG. 3 shows through holes formed. The glass was cut with a glass cutter and a cross-section was polished with #1000 and #4000 abrasive sheets sequentially. The degree of polishing was adjusted to prevent exposure of the etched modified portions to the cross-section because the exposure prevents observation of original outlines of the etched modified portions. A CNC video measuring system NEXIV VMR-6555 (product code) (manufactured by Nikon Corporation and having a magnification of 8× and a field of view of 0.58×0.44 (unit: mm)) was used as a video measuring system to observe the sample from the cross-sectional direction (thickness direction) with a focus on the holes formed by the etching.

In FIG. 3, the surface A is, of the principal surfaces of the sheet-shaped glass, the surface on which the laser beams were incident first and the fine particle-containing layer containing the fine particles was formed. The surface B is the surface on the opposite side of the surface A.

Additionally, the middle part of FIG. 3 is a cross-sectional view of the cross-section of the holes observed from the edge face (side surface) of the glass. To form the holes in the photograph from left to right, the focal point was shifted at each laser irradiation. After each hole was formed, the focal point was shifted by 25 μm to form its adjacent hole (the sheet-shaped glass was moved closer and closer to the laser as the holes were formed from left to right). Therefore, between the leftmost end and the rightmost end, there is an about 400-μm gap in the laser focal point with respect to the principal surfaces of the glass. The position marked with * in FIG. 3 indicates that the holes there were formed when the laser focal point was on the surface B of the glass, and the position is a temporary reference position. The result confirms that good holes having nearly-circular openings on the laser incident surface and having no cracks were formed.

It is also suggested that high-quality through holes can be formed even when the variation range of the focal point of applied laser beams is 1 mm at a maximum. This indicates that the hole-forming method using the glass for laser processing according to the present invention can ensure the robustness during production and is applicable also to a curved (e.g., warped) sheet-shaped glass.

### Example 2

An amount of 1.3 g of tetraethoxysilane (TEOS), 3.75 g of SNOWTEX (registered trademark) ST-OYL (product name) (manufactured by Nissan Chemical Industries, Ltd.) as hollow fine silica particles (primary particle diameter (average particle diameter): 50 to 80 nm), 2.91 g of ethanol, and 1.14 g of formic acid (0.3% solution) as a catalyst were mixed. To allow a hydrolysis reaction to proceed, the mixture was stirred until becoming clear. The reaction was subsequently allowed to proceed at 40° C. for 60 minutes, after which the resultant mixture was diluted with 3 times the amount of ethanol to obtain a coating liquid. A perforated glass was produced in the same manner as in Example 1, except for changing the coating liquid of Example 1 to the coating liquid of Example 2 and forming a fine particle-containing layer having a thickness of 125 nm on one of the principal surfaces of the sheet-shaped glass. As in Example 1, it is confirmed that good holes having nearly-circular openings on the laser incident surface and having no cracks were formed.

### Example 3

An amount of 1.3 g of tetraethoxysilane (TEOS), 2.5 g of Sfelica (registered trademark) slurry SS 120J (product name) (manufactured by JGC Catalyst and Chemicals Ltd.) as hollow fine silica particles (primary particle diameter (average particle diameter): 120 nm), 2.91 g of ethanol, and 1.14 g of a formic acid (0.3% solution) as a catalyst were mixed. To allow a hydrolysis reaction to proceed, the mixture was stirred until becoming clear. The reaction was subsequently allowed to proceed at 40° C. for 60 minutes, after which the resultant mixture was diluted with 4 times the amount of ethanol to obtain a coating liquid. A perforated glass was produced in the same manner as in Example 1, except for changing the coating liquid of Example 1 to the coating liquid of Example 3 and forming a fine particle-containing layer having a thickness of 100 nm on one of the principal surfaces of the sheet-shaped glass. As in Example 1, it is confirmed that good holes having nearly-circular openings on the laser incident surface and having no cracks were formed.

### Example 4

A perforated glass was produced in the same manner as in Example 1, except for changing the NA of the applied laser beams to 0.024. As in Example 1, it is confirmed that good holes having nearly-circular openings on the laser incident surface and having no cracks were formed.

### Example 5

A perforated glass was produced in the same manner as in Example 1, except for changing the glass to a glass having a glass composition including, in mol %: 57.775% SiO₂; 13.5% B₂O₃; 11.0% Al₂O₃; 3.0% TiO₂; 0% Na₂O; 0% Li₂O; 0% K₂O; 0% CuO; 3.0% ZnO; 4.9% MgO; 3.4% CaO; 3.4% SrO; and 0.02% Fe₂O₃, and having an absorption coefficient of 5.0/cm. As in Example 1, it is confirmed that good holes having nearly-circular openings on the laser incident surface and having no cracks were formed.

### Example 6

A perforated glass was produced in the same manner as in Example 1, except for changing the glass to a glass having a glass composition including, in mol %: 65.48% SiO₂; 7.44% B₂O₃; 10.91% Al₂O₃; 0% TiO₂; 0% Na₂O; 0% Li₂O; 0% K₂O; 0% ZnO; 6.45% MgO; 4.46% CaO; 4.46% SrO; and 0.80% CuO, and having an absorption coefficient of 11.2/cm. As in Example 1, it is confirmed that good holes having nearly-circular openings on the laser incident surface and having no cracks were formed.

### Comparative Example 1

Hole-forming process was performed under the same conditions as in Example 1, except for not forming the fine particle-containing layer on the glass principal surfaces. FIG. 4 shows the result of observing the resultant glass with a CNC video measuring system.

Under the laser conditions employed, no modified portions were formed in the vicinity of the incident surface even by shifting the focal point. This is because the light energy density was not high enough to form modified portions in the vicinity of the incident surface under the conditions. The position marked with * in FIG. 4 indicates that the holes there were formed when the laser focal point was on the surface B of the glass, and the position is a temporary reference position. As shown in FIG. 4, most of the openings have the shape of an eclipse on the opening surfaces (particularly on the surface B), and nearly perfectly circular openings as in Example 1 shown in FIG. 3 were not obtained.

Good modified portions were successfully formed in Example 1 even under the conditions same as those in Comparative Example 1, in which modified portions were unable to be formed in the vicinity of the incident surface. As a result, the good holes were successfully formed by the etching.

### INDUSTRIAL APPLICABILITY

The use of the glass for laser processing according to the present invention makes it possible to dramatically reduce the occurrence of cracks conventionally likely to occur in the vicinity of the laser beam incident surface. The use thereof also makes it possible to form, in a sheet-shaped glass, uniform through holes having nearly perfectly circular openings on the opening surfaces by the etching performed after creating major modified portions and spreading minor modified portions within the glass.

Moreover, when laser processing is performed on the glass for laser processing according to the present invention, tolerance for the focal point of laser beams to be applied is allowed to be as large as the glass thickness with respect to a target glass surface. This eliminates the need for strict adjustment of the focal point of laser beams with respect to the principal surfaces of the glass, and makes it possible to drastically reduce difficulties with production technology and management. The glass for laser processing according to the present invention is therefore industrially advantageous. Furthermore, because of the large tolerance for the focal point of laser beams, a sheet-shaped glass whose warping or irregularities can be offset by the tolerance can be processed too. This is industrially advantageous in that the need for preparation of an ultrahigh-quality glass almost free from warping is eliminated and additionally, difficulties with purchase of raw materials and with production technology and management in upstream steps can be drastically reduced. When a material having silica as a main component is used as a binder containing fine particles dispersed on the glass, the binder can be removed simultaneously with the etching mainly employing hydrofluoric acid as an etchant. This does not increase difficulty in performing the steps and is thus industrially advantageous.

### DESCRIPTION OF REFERENCE NUMERALS

1. Major modified portion
2. Spreading minor modified portion

1. A glass for laser processing, the glass having a glass composition comprising, in mol %:
45.0%≤SiO₂≤70.0%;
2.0%≤B₂O₃≤20.0%;
3.0%≤Al₂O₃≤20.0%;
0%≤ZnO≤9.0%; and
(I) 0.1%≤CuO≤2.0% and 0%≤TiO₂≤15.0%; or
(II) 0.1%≤TiO₂<5.0% and 0%≤CuO<0.1%, wherein,
in the case of (II), a metal oxide serving as a coloring component is further comprised,
a relationship of 0≤Li₂O+Na₂O+K₂O≤2.0% is satisfied,
either of principal surfaces of the glass has a layer containing fine particles, and
the fine particles have an average particle diameter of 10 nm or more and less than 1.0 μm.

2. The glass for laser processing according to claim 1, wherein the fine particles have an average particle diameter of 25 nm or more and 500 nm or less.

3. The glass for laser processing according to claim 1, wherein the layer containing the fine particles has a thickness of 10 nm or more and 10 μm or less.

4. The glass for laser processing according to claim 1, wherein the fine particles comprise an inorganic compound.

5. The glass for laser processing according to claim 4, wherein the inorganic compound is one or more compounds selected from the group consisting of SiO₂, TiO₂, ZrO₂, CeO₂, Nb₂O₅, Ta₂O₅, Al₂O₃, and MgF₂.

6. The glass for laser processing according to claim 1, wherein the layer containing the fine particles comprises a binder comprising SiO₂ as a main component.

7. The glass for laser processing according to claim 1, wherein the glass composition satisfies a relationship of 6.0%≤MgO+CaO+SrO+BaO≤25.0% in mol %.

8. The glass for laser processing according to claim 1, wherein the glass composition satisfies a relationship of 0≤Li₂O+Na₂O+K₂O<0.5% in mol %.

9. The glass for laser processing according to claim 1, wherein the glass composition comprises, in mol %, (I) 0.1%≤CuO≤2.0% and 0%≤TiO₂≤15.0%, and
a metal oxide serving as a coloring component is further comprised.

10. The glass for laser processing according to claim 1, wherein the metal oxide serving as a coloring component comprises at least one oxide of a metal selected from the group consisting of Fe, Ce, Bi, W, Mo, Co, Mn, Cr, and V.

11. The glass for laser processing according to claim 1, wherein
the glass composition comprises, in mol %: (II) 0.1%≤TiO₂<5.0% and 0%≤CuO<0.1%, wherein
a metal oxide serving as a coloring component is comprised,
the metal oxide serving as a coloring component has a composition comprising:
(III) 0.01%≤Fe₂O₃≤0.4%;
(IV) 0.1%≤CeO₂≤2.0%; or
(V) 0.01%≤Fe₂O₃≤0.4% and 0.1%≤CeO₂≤2.0%, and
a relationship of 10.0%≤MgO+CaO+SrO+BaO≤25.0% is satisfied.

12. The glass for laser processing according to claim 11, wherein the content of TiO₂ is, in mol %, 1.0%≤TiO₂<3.5%.

13. A method for producing a perforated glass, comprising the steps of:
[i] irradiating a part of the glass for laser processing according to claim 1 with a laser pulse focused by a lens, thereby forming a modified portion in the irradiated part; and
[ii] etching at least the modified portion using an etchant, thereby forming a hole in the glass for laser processing.
